(19) United States
(12) Patent Application Publication
(10) Pub. No.: US 2012/0187051 A1
(43) Pub. Date: Jul. 26, 2012

(54) METHOD FOR THE OXIDATION OF ORGANIC COMPOUNDS

(75) Inventors: Jean-Claude Setier, Lescar (FR); Jean-Louis Pornain, Pau (FR); Jean-Sébastien Dehez, Peyrehorade (FR); Frédéric Perie, Billere (FR); Jean-Marie Blondel, Etterbeek (BE); Roger Jacquet, Ottignies (BE); Jean-Christophe Renat, Nancy (FR); Laurent Clementelle, Igny (FR); Wim Plaisier, Oosterbeek (NL)

(73) Assignees: TOTAL S.A., Courbevoie (FR); ARCADIS ESG, Le Plessis Robinson (FR); TRAITEMENT VALORISATION DECONTAMINATION (TVD), Chavigny (FR); SOLVAY, Bruxelles (BE)

(21) Appl. No.: 13/499,511

(22) PCT Filed: Oct. 8, 2010
(86) PCT No.: PCT/IB10/54549

§ 371 Date: Mar. 30, 2012

(30) Foreign Application Priority Data
Oct. 9, 2009 (FR) 09 04 860

(51) Int. Cl. C02F 1/72; B09C 1/08

(52) U.S. Cl. 210/759; 405/128.75; 210/763

(57) ABSTRACT

The disclosure relates to a method for oxidising one or more organic compounds, including placing the organic compounds in contact with at least one oxidising agent as well as with a catalyst agent including at least one source of divalent or trivalent transition metal ions and at least one poly-α-hydroxyacrylic acid and/or a poly-α-hydroxyacrylate. The disclosure can be used for removing pollutants from soils.

### CROSS-REFERENCE TO RELATED APPLICATIONS

This application is a National Phase Entry of International Application No. PCT/IB2010/054549, filed on Oct. 8, 2010, which claims priority to French Patent Application Serial No. 09 04860, filed on Oct. 9, 2009, both of which are incorporated by reference herein.

### TECHNOLOGICAL FIELD

The present invention relates to a method for the oxidation of organic compounds, in particular organic compounds present in the environment (for example in the soil or in an aquifer), as well as a method for in situ depollution of soil containing organic compounds.

### TECHNOLOGICAL BACKGROUND

The treatment of soils and underground waters that are contaminated by pollutants, in particular organic pollutants, represents an increasing challenge owing to the difficulty of its implementation as well as the cost involved. Excavation of soils is a technique that can be envisaged, but is extremely costly and sometimes impossible to carry out. For this reason, ongoing research is concentrated principally on in situ treatment of pollutants.

Incineration of contaminated soils is a first possible in situ method, but has the drawback of producing harmful by-products such as polychlorinated dibenzo-p-dioxins (PCDD) and polychlorinated dibenzofurans (PCDF). A second method is in situ biological treatment or bioremediation. However, this second method is ineffective with some pollutants that are biorefractary or toxic for the micro-organisms.

A third method is in situ chemical treatment. The latter conventionally comprises injecting hydrogen peroxide or a source of hydrogen peroxide into the soil. Hydrogen peroxide breaks down to form hydroxyl radicals capable of reacting with organic pollutants. In order to promote the formation of hydroxyl radicals, it is known to use a catalyst such as the ferrous ion Fe²⁺, in order to reproduce the so-called Fenton's reaction.

However, Fenton's reaction takes place in principle at a pH of 3-4. However, soils are generally at a neutral or basic pH, and the injection of acid in order to obtain a favourable pH is undesirable, as such an injection would lead to further pollution of the soil not only by the acid but also by heavy metals solubilized by the acid. For this reason a chelating agent is generally used in order to protect the catalyst and to be able to carry out Fenton's reaction at a neutral, basic or weakly acid pH. The chelating agent that is most used is ethylenediaminetetraacetic acid (EDTA).

Thus, document WO 01/02105 describes an in situ treatment method for contaminants in which an oxidizing agent and a reagent comprising an aqueous solution at pH 5-8 containing a catalyst are injected into the soil. Document WO 2004/002902 describes a method for the oxidation of organic compounds comprising placing the organic compounds in contact with a composition comprising a soluble peroxygen compound and a source of divalent or trivalent transition metal in combination with a chelating agent. Document WO 2004/002923 describes a method for the oxidation of organic compounds comprising placing the organic compounds in contact with a soluble peroxygen compound and a pH modifier maintaining the pH within a range of 6 to 10. A divalent or trivalent transition metal can also be present in combination with a chelating agent.

Document WO 2005/012181 describes an in situ treatment for polluted soil comprising the injection of persulphate and hydrogen peroxide into the soil in the presence of an activator such as a transition metal combined with a chelating agent. Document WO 2005/081996 describes a method for the oxidation of an organic compound comprising placing this compound in contact with a composition comprising a water-soluble peroxygen compound and a pH modifier maintaining the pH of the composition at a value greater than 10. A divalent or trivalent transition metal can also be present in combination with a chelating agent.

Document WO 2005/118170 describes an in situ treatment for polluted soil comprising injecting hydrogen peroxide or calcium, magnesium or zinc peroxide or sodium percarbonate and a metal chelate into the soil. Document WO 2006/128797 describes a method for the oxidation of an organic compound comprising placing the compound in contact with a composition comprising a persulphate and a percarbonate or a metallic peroxide. An activator constituted by a transition metal combined with a chelating agent can be added. Document WO 2007/047946 describes a method for the oxidation of a contaminant present in the environment, said method comprising placing the contaminant in contact with a composition comprising a water-soluble peroxygen compound and zerovalent iron. Document WO 2007/138058 describes the use of a solid product composed of an inorganic peroxide and an inorganic hydroxide, oxide or carbonate containing the same metal, for treating contaminated water or soils.

However, EDTA, the chelating agent used in practice in the state of the art, is considered non-biodegradable, although it can sometimes be biodegraded with great difficulty under very specific conditions. Thus EDTA can itself pollute the soil. A need therefore exists to provide an in situ depollution method that has a better ecological balance, i.e. in which a smaller quantity of chemical products are injected into the soil and/or in which the biodegradability of the chemical products injected is better and/or the efficiency of which in terms of degradation of the pollutants is improved.

### SUMMARY

The invention therefore provides a method for the oxidation of one or more organic compounds, comprising placing the organic compounds in contact with at least one oxidizing agent as well as with a catalyzing agent comprising at least one source of divalent or trivalent transition metal ions and at least one poly-α-hydroxyacrylic acid and/or a poly-α-hydroxyacrylate. According to an embodiment, the organic compounds are present in the soil, a watercourse, underground water, an industrial effluent or wastewater. Another subject of the invention is a depollution method for soil containing one or more organic compounds, comprising placing the organic compounds in contact with at least one oxidizing agent as well as with a catalyzing agent comprising at least one source of divalent or trivalent transition metal ions and at least one poly-α-hydroxyacrylic acid and/or a poly-α-hydroxyacrylate. According to an embodiment, said placing in contact is carried out by injecting the oxidizing agent as well as the catalyzing agent into the soil.

In the above methods, the oxidizing agent can be chosen from hydrogen peroxide, sodium, potassium or ammonium persulphate, sodium or potassium percarbonate, sodium or potassium perborate, calcium, zinc or magnesium peroxide, and mixtures thereof. In the above methods, the source of divalent or trivalent transition metal ions can be a salt the cation of which is chosen from Fe²⁺, Fe³⁺, Cu²⁺, Mn²⁺ or Zn²⁺, and the anion is chosen from chloride, nitrate or sulphate, preferably iron sulphate. In the above methods, the organic compounds are chosen from trichloroethylene, vinyl chloride, tetrachloroethylene, methylene chloride, 1,2-dichloroethane, 1,1,1-trichloroethane, carbon tetrachloride, chloroform, chlorobenzenes, benzene, toluene, xylene, tert-butanol, ethylbenzene, methylbenzene, ethylene dibromide, methyl tert-butyl ether, polyaromatic hydrocarbons, polychlorobiphenyls, phthalates, 1,4-dioxane, nitrosodimethylamine, nitroanilines and trinitrotoluene.

According to an embodiment, the method for the depollution of soil comprises successively:
1) injecting the oxidizing agent into the soil; and
2) injecting the catalyzing agent into the soil.

According to an embodiment, the method for the depollution of soil comprises successively:
1) injecting a poly-α-hydroxyacrylic acid and/or a poly-α-hydroxyacrylate into the soil;
2) injecting the oxidizing agent into the soil; and
3) injecting the catalyzing agent into the soil.

According to an embodiment, the method for the depollution of soil comprises successively:
1) injecting the catalyzing agent into the soil.
2) injecting a washing solution into the soil; and
3) injecting the oxidizing agent into the soil.

Another subject of the invention is the use of a poly-α-hydroxyacrylic acid and/or a poly-α-hydroxyacrylate as a chelating agent, in combination with a source of divalent or trivalent transition metal ions, for the depollution by means of an oxidizing agent of a soil containing one or more organic compounds, advantageously, in situ in the soil. The present invention makes it possible to overcome the drawbacks of the state of the art. It provides more particularly a soil depollution method, in particular in situ, that has a better ecological balance, i.e. in which a smaller quantity of chemical products is used and/or in which the biodegradability of the chemical products injected is better and/or the efficiency of which in terms of degradation of the pollutants is improved. This is accomplished by using poly-α-hydroxyacrylate as a chelating agent within the framework of a modified Fenton's reaction (i.e. a Fenton's reaction at a neutral, basic or weakly acid pH).

According to some particular embodiments, the present invention also has one or preferably several of the advantageous features listed below.
The invention makes it possible to inject a smaller quantity of oxidizing agent into the soil, for an equivalent efficiency in terms of decontamination (i.e. of quantity of organic compounds treated), with respect to the state of the art.
Alternatively, for the same quantity of oxidizing agent, the invention makes it possible to obtain an increased efficiency in terms of decontamination, with respect to the state of the art.
Replacing EDTA by a poly-α-hydroxyacrylate improves the biodegradability of the compounds used in the method.
The injection of poly-α-hydroxyacrylate into the soil prior to that of the oxidizing agent makes it possible to further reduce the quantity of oxidizing agent necessary for the decontamination, in particular by acting as a chelating agent of the metals naturally present in the soil.

### DETAILED DESCRIPTION OF EMBODIMENTS

The invention is now described non-limitatively in greater detail in the following description. The invention relates to a method for the oxidation of one or more organic compounds. This oxidation method comprises placing the organic compounds in contact on the one hand with an oxidizing agent, and on the other hand with a catalyzing agent comprising a source of divalent or trivalent transition metal ions and a poly-α-hydroxyacrylate (as chelating agent). The oxidation method according to the invention is preferably carried out at a pH greater than or equal to 5, or greater than or equal to 6, or greater than or equal to 7, or greater than or equal to 8, or greater than or equal to 9, or greater than or equal to 10.

By “organic compound” is meant a molecule comprising at least one carbon atom bound to at least one hydrogen atom. The organic compounds can in particular be pesticides or herbicides, volatile, semi-volatile or non-volatile natural or artificial hydrocarbons, optionally chlorinated, brominated, aromatic or polyaromatic, propergol, explosives, etc. By way of example of organic compounds, there can be mentioned chlorinated compounds including trichloroethylene, vinyl chloride, tetrachloroethylene, methylene chloride, 1,2-dichloroethane, 1,1,1-trichloroethane, carbon tetrachloride, chloroform, chlorobenzenes and polychlorobiphenyls; non-chlorinated compounds including benzene, toluene, xylene, tert-butanol, ethylbenzene, methylbenzene, ethylene dibromide, methyl-tert-butyl-ether, polyaromatic hydrocarbons (for example naphthalene), phthalates, 1,4-dioxane, nitrosodimethylamine, nitroanilines and trinitrotoluene.

The organic compounds can be present in a watercourse, underground water, an industrial effluent or wastewater. By “wastewater” is meant water mixed with human or household waste, in particular sewage. They can also and preferably be present in the soil. Thus, the oxidation method according to the invention can itself be used more particularly within the framework of a method for the depollution of soil containing one or more organic compounds: the method for the depollution of soil thus comprises the oxidation of the organic compounds in the soil according to the method of the invention.

The term “soil” here denotes generally the surface layer of the earth's crust. The soil comprises, according to circumstances, sediments, clays, rocks, sands and others. The term “soil” also covers ground containing water, such as aquifers and groundwater.

The method for the depollution of soil can be ex situ. In this case, all or part of the materials of which the soil is constituted are removed, treated on the surface by means of the oxidation method according to the invention, then returned to the site or used for an industrial or commercial application. But, preferably, the method for the depollution of soil is in situ. In this case, the oxidation method according to the invention is carried out in the soil itself, by respective injection into the soil of the oxidizing agent and the catalyzing agent.

By “oxidation” is meant a chemical reaction between the oxidizing agent and the organic compound or compounds, by which the sum of the oxidation numbers of the carbon atoms of the organic compounds increases. The catalyzing agent catalyzes this oxidation. The oxidizing agent used within the framework of the invention is generally present in solution or in an aqueous suspension. Similarly for the poly-α-hydroxyacrylic acid and the poly-α-hydroxyacrylate, as well as for the source of divalent or trivalent transition metal ions.

The oxidizing agent can be in particular:
hydrogen peroxide;
sodium, potassium or ammonium persulphate, the term “persulphate” covering both mono- and dipersulphate, sodium persulphate being preferred;
sodium or potassium percarbonate, sodium percarbonate being preferred;
monohydrated or heptahydrated sodium or potassium perborate;
calcium, zinc or magnesium peroxide; or
a mixture of the previous compounds.
   Calcium, zinc or magnesium peroxide is a solid compound that decomposes in a solution at pH 6-7 to provide hydrogen peroxide. This is therefore a more stable source of hydrogen peroxide than hydrogen peroxide itself.

The source of divalent or trivalent transition metal ions used in the invention can be in particular a salt the cation of which is chosen from Fe²⁺, Fe³⁺, Cu²⁺, Mn²⁺ or Zn²⁺. The anion is generally chosen from chloride, nitrate or sulphate. Preferably, this source of ions is iron sulphate. Mixtures of the above sources of ions are also possible.

As chelating agent poly-α-hydroxyacrylic acid or a poly-α-hydroxyacrylate are used. The term “poly-α-hydroxyacrylate” here denotes any alkali or alkaline-earth metal or ammonium salt of poly-α-hydroxyacrylic acid, or a derivative thereof. Preferably, this is a sodium salt of poly-α-hydroxyacrylic acid.

In the following, unless mentioned otherwise, any description of an embodiment by reference to poly-α-hydroxyacrylate also covers the acid form. The poly-α-hydroxyacrylate is therefore the hydroxycarboxylated polymer having a structure of the [C(R₁)(R₂)—C(OH)(COOM)]ₙ, type where R₁ and R₂ represent a hydrogen atom or a C₁-C₃ alkyl group, M represents an alkali or alkaline-earth metal atom or an ammonium group, and n represents an integer greater than or equal to 3. Advantageously, R₁ and/or R₂ represent a hydrogen atom or a methyl group. Preferably, the poly-α-hydroxyacrylate is a homopolymer in which R₁═R₂═H. Advantageously, M represents Na.

The average molecular weight of the poly-α-hydroxyacrylate used within the framework of the invention is preferably comprised approximately between 20000 and 140000, which corresponds to a value of n comprised approximately between 180 and 1275 in the case of sodium poly-α-hydroxyacrylate. Preferably, the molecular weight is greater than or equal to 26000 (n greater than or equal to 236), for an optimal chelating power.

Reference is made in this regard to document FR 2118627, which presents poly-α-hydroxyacrylates as described here, as well as examples of the synthesis of these compounds and their application as “builders” in detergent compositions. Reference is also made to documents BE 786464 and FR 2237916, which describe methods of producing poly-α-hydroxyacrylates.

Document FR 2193875 describes oxidizing agents obtained by the action of hydrogen peroxide on poly-α-hydroxyacrylic acid. Document FR 2250821 describes premixes of poly-α-hydroxyacrylate and a surfactant for detergent compositions. Documents FR 2338345 and FR 2367858 describe the use of poly-α-hydroxyacrylates for the regeneration of waste paper. Document EP 0017193 describes the use of poly-α-hydroxyacrylate in combination with a peroxide compound for coating seeds. Document FR 2457339 mentions the possibility of using a poly-α-hydroxyacrylate within the framework of a method for the delignification and bleaching of chemical and semi-chemical cellulose pulps. Document FR 2459203 describes particles of peroxygenated compounds stabilized by a poly-α-hydroxyacrylate, and the use of these particles for bleaching and cleaning.

According to an embodiment, the in situ soil depollution method according to the invention comprises (preferably consists of) successively:
1) injecting a poly-α-hydroxyacrylate into the soil;
2) injecting the oxidizing agent into the soil; and
3) injecting the catalyzing agent, comprising a source of divalent or trivalent transition metal ions and a poly-α-hydroxyacrylate as a chelating agent into the soil.
   The poly-α-hydroxyacrylate in step 3) can be the same as that in step 1). In step 1), the poly-α-hydroxyacrylate is injected without being combined with a source of divalent or trivalent transition metal ions.

This embodiment makes it possible to reduce significantly the quantity of oxidizing agent necessary to carry out the depollution. In fact, owing to the presence of transition metals in the soil, the oxidizing agent undergoes a decomposition on injection into the soil before reaching the target organic compounds. As a result, the prior injection of poly-α-hydroxyacrylate makes it possible to complex the transition metals present in the soil and therefore to limit the decomposition of the oxidizing agent when it is injected.

According to another embodiment, the in situ soil depollution method according to the invention comprises (preferably consists of) successively:
1) injecting the oxidizing agent into the soil; and
2) injecting the catalyzing agent, comprising the source of divalent or trivalent transition metal ions and the poly-α-hydroxyacrylate as a chelating agent into the soil.
   This embodiment has the advantage of being simple to implement.

According to another embodiment, the in situ soil depollution method according to the invention comprises (preferably consists of) successively:
1) injecting the catalyzing agent comprising the source of divalent or trivalent transition metal ions and the poly-α-hydroxyacrylate as chelating agent into the soil;
2) injecting a washing solution into the soil; and
3) injecting the oxidizing agent into the soil.

The washing solution can be water or any suitable aqueous solution. Injection of the washing solution makes it possible to convey the catalyzing agent to the polluted area (portion of soil containing the organic compounds to be treated) while avoiding unnecessarily leaving large quantities of catalyzing agent between the site of injection and the polluted area. In this way the quantity of catalyzing agent to be used is limited. Moreover, the oxidizing agent can be injected subsequently, and in the substantial absence of catalyzing agent between the site of injection and the polluted area, the decomposition of the oxidizing agent between the site of injection and the polluted area can be avoided.

The various products are injected into the soil according to any technique known to a person skilled in the art, for example by means of one or more injection wells. The solid products are in general incorporated or dissolved in an aqueous solution prior to their injection in order to allow their dispersion in the soil. However, in the case where the injection takes place directly into an underground water body, it may be possible to inject the products directly in solid form. With respect to liquid products (for example hydrogen peroxide), they can be mixed with water or an aqueous solution prior to their injection in order to achieve an optimal concentration. The quantity of products to be injected and/or the injection flow rate are determined by a person skilled in the art according to the characteristics of the site, such as the extent of the geographical area to be treated, the distance between two neighbouring injection points, the nature of the organic compounds to be treated and their content in the soil, the temperature, the presence of groundwater, if any, and the velocity of the water therein.

In the implementation of the method according to the invention:
the percentage by mass of the oxidizing agent is preferably from 5 to 50%, and more preferably from 5 to 30% and even more preferably from 5 to 15% of the solution;
the percentage by mass of the source of divalent or trivalent transition metal ions is preferably from 0.01 to 1%, and more preferably from 0.05 to 0.2% of the solution.
the percentage by mass of the poly-α-hydroxyacrylic acid or the poly-α-hydroxyacrylate is preferably from 0.01 to 1%, and more preferably from 0.1 to 0.5% of the solution.

In particular, when the oxidizing agent is percarbonate, its percentage by mass is preferably from 5 to 12%. When the oxidizing agent is persulphate, its percentage by mass is preferably from 20 to 50%, and more preferably from 30 to 45%. When the oxidizing agent is hydrogen peroxide, its percentage by mass is preferably from 5 to 30% and even more preferably from 5 to 15%.

### EXAMPLES

The following examples illustrate the invention without limiting it.

### Example 1

### Laboratory Tests

Sediments are sampled from a site contaminated by organic compounds. The sediments are sieved at 9 mm, and the passing portion is retained. The sediments are mixed and homogenized.

In the following, measurement of the total hydrocarbon content is carried out after filtration on a 0.2-0.8 μm filter, by gas chromatography coupled with a flame ionization detector (GC/FID). The initial total hydrocarbon content is 29.5 mg/l. A fraction of 250 g of sediments is mixed with 500 mL of a 100 g/L aqueous solution of sodium percarbonate. The mixture is placed on a vibrating table for 3 hours, after which 450 mL of leachate is collected.

A sample A (according to the prior art) is obtained by: sampling 200 mL of leachate, mixing with 0.46 g of heptahydrated iron sulphate, 0.48 g of EDTA and 8.4 mL of a 30% aqueous hydrogen peroxide solution, and shaking on a vibrating table for 48 hours. Measurement of the total hydrocarbon content shows an abatement of almost 100%.

A sample B (according to the invention) is obtained by: sampling 200 mL of leachate, mixing with 0.46 g of heptahydrated iron sulphate, 0.28 g of Interox® Solv-X available from Solvay (concentration by weight in dry extract of sodium polyhydroxyacrylate of 10%) and 8.4 mL of a 30% aqueous hydrogen peroxide solution, and shaking on a vibrating table for 48 hours. Measurement of the total hydrocarbon content shows an abatement of almost 80%.

### Example 2

### Tests on a Pilot Site

On a site where the groundwater is contaminated by hydrocarbons, in particular benzene (average content 10 mg/L). There are two injection wells per pilot.

A test is carried out under two different conditions:
In a first pilot, 1000 L of a 50% aqueous hydrogen peroxide solution diluted in approximately 9000 L of water, then 200 L of Interox® Solv-X and 16 kg of heptahydrated iron sulphate diluted in approximately 1000 L was injected.
In a second pilot, 1500 kg of sodium percarbonate incorporated in solution in approximately 9000 L of water was injected, then 140 L of Interox® Solv-X and 14 kg of heptahydrated iron sulphate diluted in approximately 1000 L water was injected.

In each case, the hydrocarbon content present in the groundwater is measured in five measurement wells placed downstream (according to the direction of flow of the groundwater) of the respective injection points.

In the first pilot, downstream of the injection point, an average abatement of the total hydrocarbon content is noted that is comprised between 50 and 70% after 7 days, with a stabilization at fifty days at approximately 70% for most measurement wells. Moreover, a reduction in the benzene content is noted that is comprised between approximately 50 and 80% between 5 and 20 days after injection.

In the second pilot, downstream of the injection point, an average abatement of the total hydrocarbon content is noted that is comprised between 10 and 25% after 5 days, with a stabilization at fifty days at approximately 40% for most of the measurement wells. Moreover, a reduction in the benzene content is noted that is comprised between approximately 40 and 60% after 5 days, with a stabilization at approximately 30% after 20 days for most measurement wells. These results are explained by the leaching capacity of sodium percarbonate, i.e. its capacity to desorb the hydrocarbons fixed on the soil particles.

The pilots show the efficiency of oxidation treatments in the presence of Interox® Solv-X (sodium polyhydroxyacrylate) as a complex-forming agent for ferrous iron. The impact of the treatments on the total hydrocarbons parameter continues for a period of at least 50 days. Compared to the renewal period of the underground water in the pilots (15 to 20 days), the effectiveness at 50 days shows a persistent effect of the treatments.

1. A method for the oxidation of one or more organic compounds, comprising placing the organic compounds in contact with at least one oxidizing agent as well as with a catalyzing agent comprising at least one source of divalent or trivalent transition metal ions and at least one of: (a) poly-α-hydroxyacrylic acid or (b) a poly-α-hydroxyacrylate, in which the organic compounds are present in at least one of: (a) the soil, (b) a watercourse, (c) underground water, (d) an industrial effluent or (e) wastewater.

2. The method according to claim 1 in which the oxidizing agent is chosen from hydrogen peroxide, sodium, potassium or ammonium persulphate, sodium or potassium percarbonate, sodium or potassium perborate, calcium, zinc or magnesium peroxide, and mixtures thereof.

3. The method according to claim 1, in which the source of divalent or trivalent transition metal ions is a salt the cation of which is chosen from Fe²⁺, Fe³⁺, Cu²⁺, Mn²⁺ or Zn²⁺, and the anion is chosen from chloride, nitrate or sulphate.

4. The method according to claim 1, in which the organic compounds are chosen from trichloroethylene, vinyl chloride, tetrachloroethylene, methylene chloride, 1,2-dichloroethane, 1,1,1-trichloroethane, carbon tetrachloride, chloroform, chlorobenzenes, benzene, toluene, xylene, tert-butanol, ethylbenzene, methylbenzene, ethylene dibromide, methyl tert-butyl ether, polyaromatic hydrocarbons, polychlorobiphenyls, phthalates, 1,4-dioxane, nitrosodimethylamine, nitroanilines and trinitrotoluene.

5. A depollution method for soil containing one or more organic compounds, comprising placing the organic compounds in contact with at least one oxidizing agent as well as with a catalyzing agent comprising at least one source of divalent or trivalent transition metal ions and at least one of: (a) poly-α-hydroxyacrylic acid, or (b) a poly-α-hydroxyacrylate.

6. The method according to claim 5, in which the placing in contact is carried out by injecting the oxidizing agent as well as the catalyzing agent into the soil.

7. The method according to claim 5, in which the oxidizing agent is chosen from hydrogen peroxide, sodium, potassium or ammonium persulphate, sodium or potassium percarbonate, sodium or potassium perborate, calcium or magnesium peroxide, and mixtures thereof.

8. The method according to claim 5, in which the source of divalent or trivalent transition metal ions is a salt the cation of which is chosen from Fe²⁺, Fe³⁺, Cu²⁺, Mn²⁺ or Zn²⁺, and the anion is chosen from chloride, nitrate or sulphate.

9. The method according to claim 5, in which the organic compounds are chosen from trichloroethylene, vinyl chloride, tetrachloroethylene, methylene chloride, 1,2-dichloroethane, 1,1,1-trichloroethane, carbon tetrachloride, chloroform, chlorobenzenes, benzene, toluene, xylene, tert-butanol, ethylbenzene, methylbenzene, ethylene dibromide, methyl tert-butyl ether, polyaromatic hydrocarbons, polychlorobiphenyls, phthalates, 1,4-dioxane, nitrosodimethylamine, nitroanilines and trinitrotoluene.

10. The method according to claim 5, comprising successively:
1) injecting the oxidizing agent into the soil; and
2) injecting the catalyzing agent into the soil.

11. The method according to claim 5, comprising successively:
1) injecting a poly-α-hydroxyacrylic acid and/or a poly-α-hydroxyacrylate into the soil;
2) injecting the oxidizing agent into the soil; and
3) injecting the catalyzing agent into the soil.

12. The method according to claim 5, comprising successively:
1) injecting the catalyzing agent into the soil;
2) injecting a washing solution into the soil; and
3) injecting the oxidizing agent into the soil.

13. A use of at least one of: (a) a poly-α-hydroxyacrylic acid, or (b) a poly-α-hydroxyacrylate, as a chelating agent, in combination with a source of divalent or trivalent transition metal ions, for the depollution by an oxidizing agent of a soil containing one or more organic compounds.

14. The use according to claim 13, in situ in the soil.

15. The method according to claim 1, in which the source of divalent or trivalent transition metal ions is iron sulphate.

16. The method according to claim 5, in which the source of divalent or trivalent transition metal ions is iron sulphate.
